(19) United States
(12) Patent Application Publication
(10) Pub. No.: US 2009/0213586 A1
(43) Pub. Date: Aug. 27, 2009

(54) LED sticker

(76) Inventor: Kuan-Lin Peng, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/071,614

(22) Filed: Feb. 25, 2008

(51) Int. Cl. F21V 33/00; B60Q 1/00

(52) U.S. Cl. 362/234; 362/487

(57) ABSTRACT

Disclosed is a LED sticker, which includes a sticker body made out of a flexible plastic material and having multiple light transmissive portions, a plurality of light emitting diodes respectively embedded in the light transmissive portions, a control circuit assembly mounted on the sticker body and electrically connected with the light emitting diodes with a respective lead wire for controlling operation of the light emitting diodes and having a battery cell for providing the light emitting diodes with the necessary working voltage, and a flexible magnetic pad or double-sided adhesive member fixedly provided at the bottom side of the sticker body for securing the sticker body to a vehicle by means of magnetic attraction or adhesion.

### BACKGROUND OF THE INVENTION

1. Field of the Invention

The present invention relates a decorative sticker and more particularly, to a LED sticker that can be adhered to a vehicle for decoration as well for giving a visual warning signal.

2. Description of the Related Art

Many vehicle reflective stickers are commercially available. These reflective stickers can be adhered to a car, motorcycle, motorcycle helmet, etc., to reflect light, giving a warning signal. However, these reflective stickers cannot give a warning signal when not radiated with light at night. Further, the color of a reflective sticker becomes less bright after a long use.

Further, a vehicle generally has warning signal lights controllable to give a visual warning signal. These warning signal lights are fixedly disposed at predetermined locations. This fixed location design of warning signal lights consume much energy. Because these warning signal lights are fixedly provided at predetermined locations, they cannot effectively attractive people not at right behind. Because these warning signal lights are constantly turned on at night, they waste much energy.

### SUMMARY OF THE INVENTION

The present invention has been accomplished under the circumstances in view.

According to one aspect of the present invention, the LED sticker comprises a sticker body made out of a flexible plastic material and having multiple light transmissive portions, a plurality of light emitting diodes respectively embedded in the light transmissive portions, a control circuit assembly mounted on the sticker body and electrically connected with the light emitting diodes with a respective lead wire for controlling operation of the light emitting diodes and having a battery cell for providing the light emitting diodes with the necessary working voltage, and a flexible magnetic pad fixedly provided at the bottom side of the sticker body for securing the sticker body to a vehicle by means of magnetic attraction.

According to another aspect of the present invention, the sticker body can be made in any of a variety of shapes or designs to provide a decorative effect.

According to still another aspect of the present invention, the control circuit assembly uses a vibration switch to control on/off status of the LEDs subject to vibrations.

A to still another aspect of the present invention, the control circuit assembly comprises a USB jack for the connection of a USB cable to obtain power supply from a computer. Alternatively, the control circuit assembly can be provided with a power jack for the connection of a power adapter cable to obtain power supply from an external power source.

### BRIEF DESCRIPTION OF THE DRAWINGS

FIG. 1 is an exploded view of a LED sticker according to the present invention.

FIG. 2 is a schematic assembly view of the LED sticker according to the present invention.

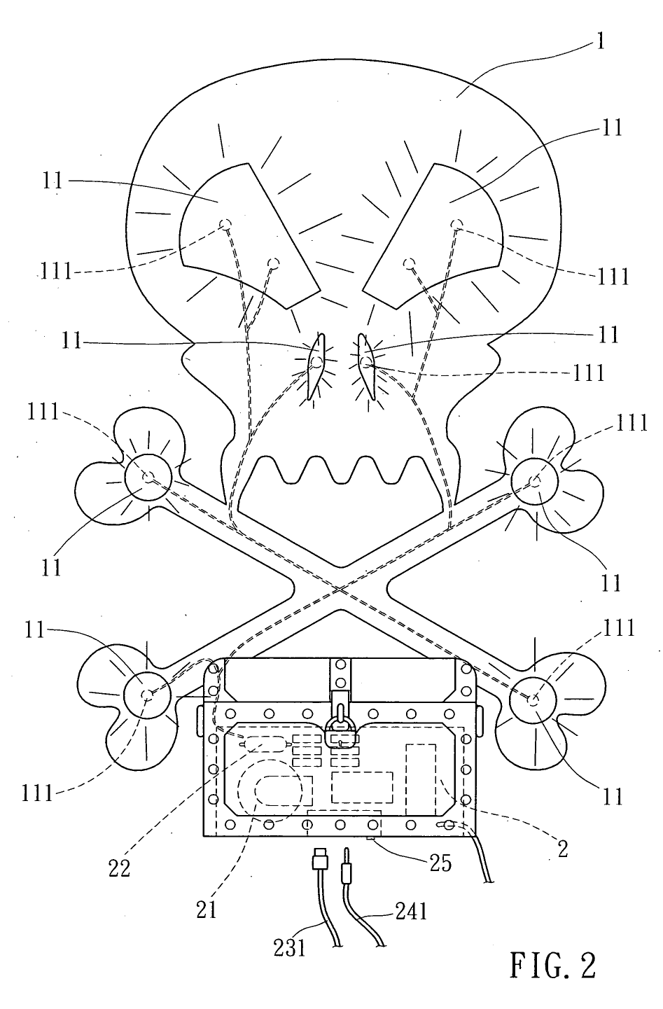

FIG. 3 is an elevational view of a part of the LED sticker according to the present invention, showing the structure of the control circuit assembly.

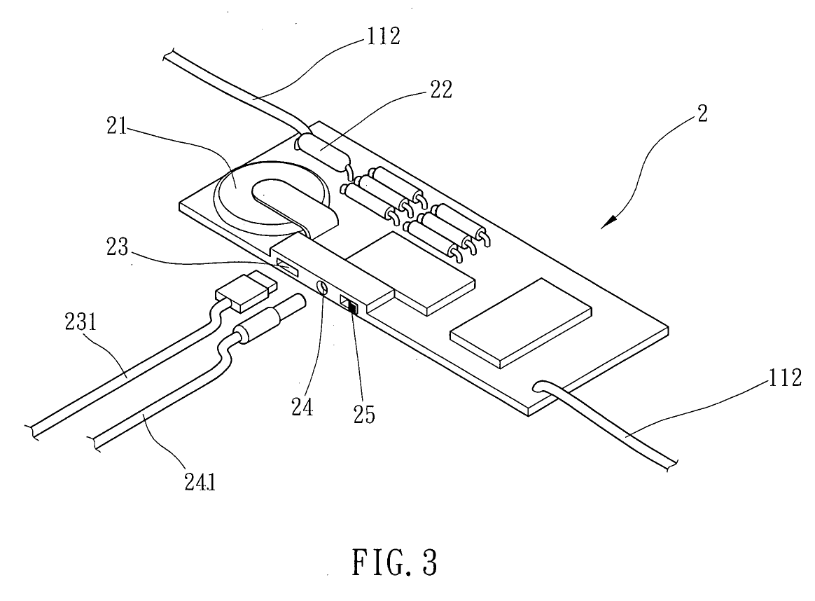

FIG. 4 is a schematic drawing showing an application example of the present invention.

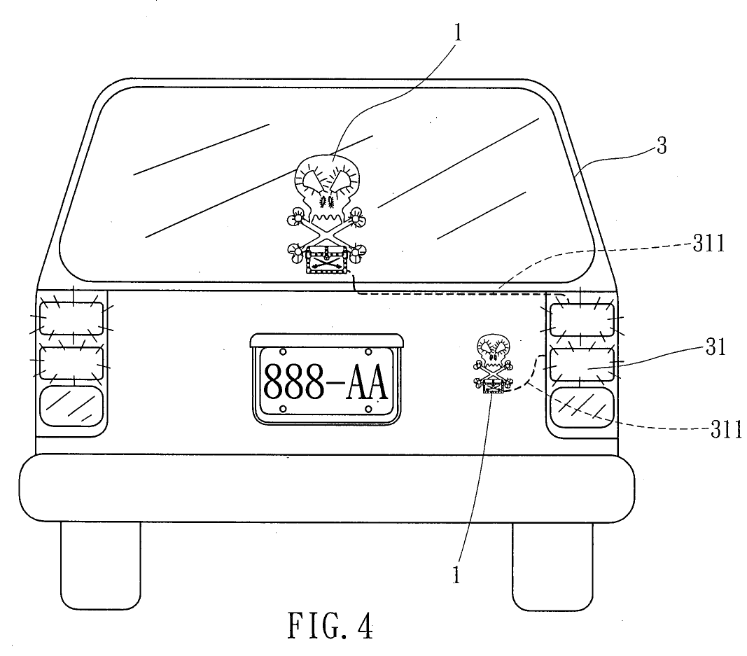

FIG. 5 is an exploded view of an alternate form of the LED sticker according to the present invention.

### DETAILED DESCRIPTION OF THE INVENTION

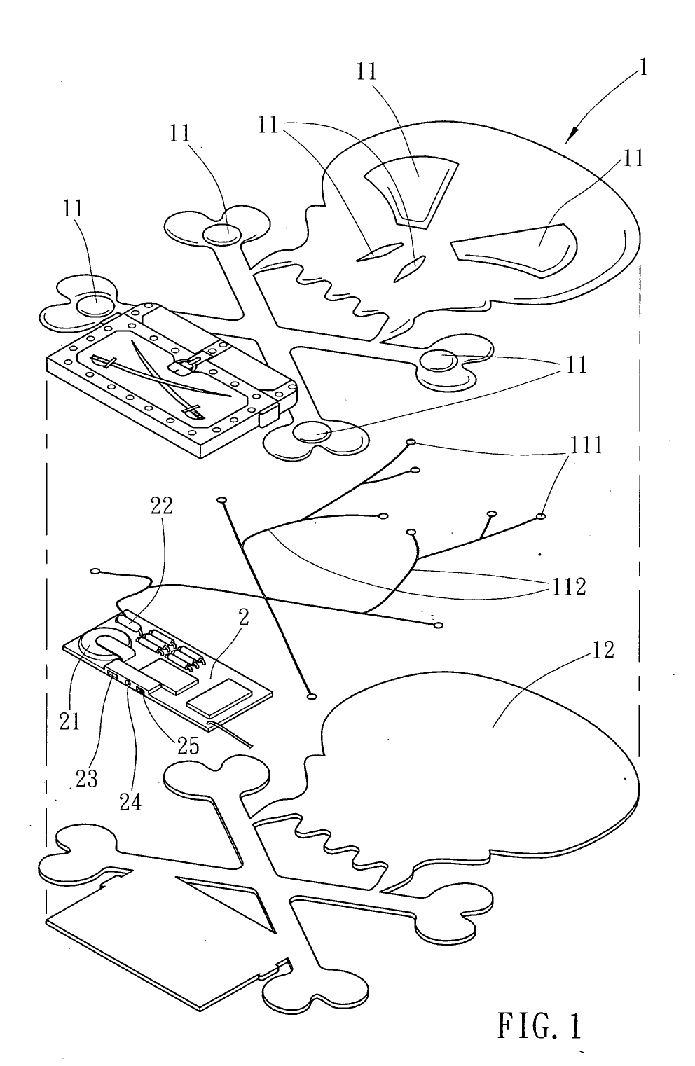

Referring to FIGS. 1˜4, a LED sticker in accordance with the present invention is shown comprising a sticker body 1 and a control circuit assembly 2. The sticker body 1 is made out of a flexible plastic material, having multiple light transmissive portions 11, a LED (light emitting diode) 111 respectively embedded in each light transmissive portion 11, and a flexible magnetic pad 12 provided at the bottom side for securing to the ferrite frame of a vehicle 3 by means of magnetic attraction. The control circuit assembly 2 comprises a battery cell 21 adapted to provide the necessary working voltage to the LEDs 111, a vibration switch 22 electrically connected with the LEDs 111 by means of lead wires 112 for controlling On/Off status of the LEDs 111 subject to vibration. The control circuit assembly 2 may be electrically coupled to the stop lights 31 of the vehicle 3 with lead wires 311 for use as a third stop light. The control circuit assembly 2 further comprises a power switch 25 for manual power on/off control, a USB jack 23 for the connection of a USB cable 231 to obtain power supply from a computer, and a power jack 24 for the connection of a power adapter cable 241 to obtain power supply from an external power source.

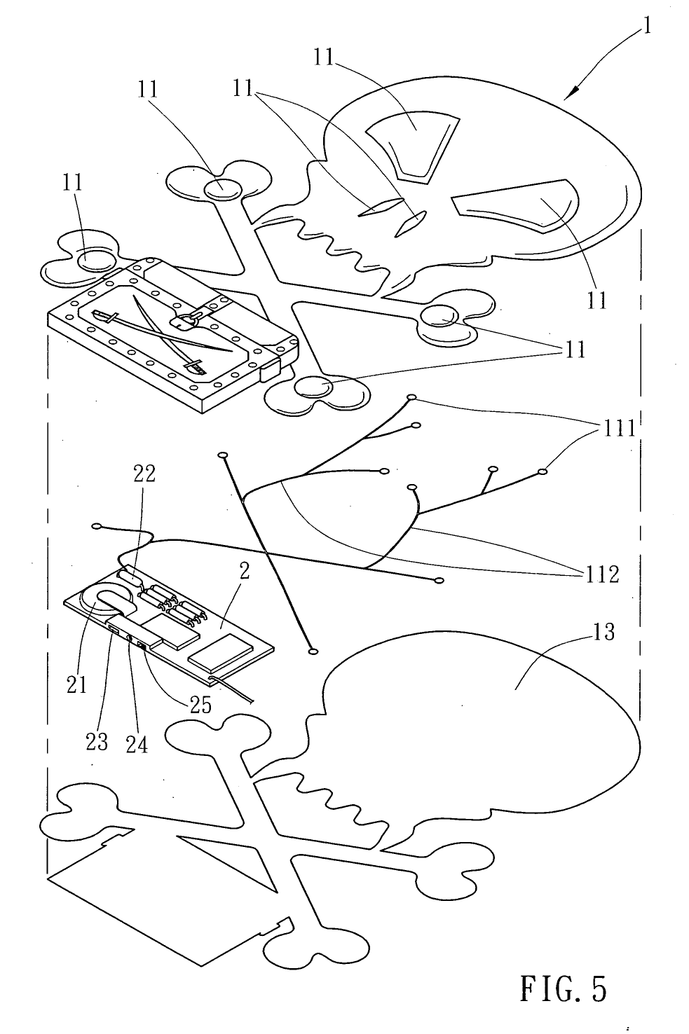

FIG. 5 shows an alternate form of the present invention. This embodiment is substantially similar to the embodiment shown in FIGS. 1˜4 with the exception that a double-sided adhesive member 13 is used to substitute for the aforesaid flexible magnetic pad 12.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A LED sticker comprising:
a sticker body made out of a flexible plastic material, said sticker body having multiple light transmissive portions;
a plurality of light emitting diodes respectively embedded in said light transmissive portions;
a control circuit assembly mounted on said sticker body and electrically connected with said light emitting diodes with a respective lead wire for controlling operation of said light emitting diodes, said control circuit assembly comprising a battery cell for providing said light emitting diodes with the necessary working voltage; and
a flexible magnetic pad fixedly provided at a bottom side of said sticker body for securing said sticker body to a ferrite member by means of magnetic attraction.

2. The LED sticker as claimed in claim 1, wherein said control circuit assembly comprises a vibration switch electrically connected with said lead wires for controlling on/off status of said light emitting diodes subject to a vibration.

3. The LED sticker as claimed in claim 1, wherein said control circuit assembly comprises a power switch for manual power on/off control.

4. The LED sticker as claimed in claim 1, wherein said control circuit assembly is electrically coupled to the stoplights of a vehicle with lead wires.

5. The LED sticker as claimed in claim 1, wherein a double-sided adhesive member is provided at a bottom side of said sticker body for mounting.

6. The LED sticker as claimed in claim 1, wherein said control circuit assembly comprises a USB jack for the connection of a USB cable to obtain power supply from a computer.

7. The LED sticker as claimed in claim 1, wherein said control circuit assembly comprises a power jack for the connection of a power adapter cable to obtain power supply from an external power source.
